(19) United States
(12) Patent Application Publication
(10) Pub. No.: US 2024/0187994 A1
(43) Pub. Date: Jun. 6, 2024

(54) NETWORK AUTOMATIC CONTROL METHOD, APPARATUS AND DEVICE FOR TRACKER, AND STORAGE MEDIUM

(71) Applicant: ZTE CORPORATION, Shenzhen (CN)

(72) Inventor: Quan SUN, Shenzhen (CN)

(21) Appl. No.: 18/552,521

(22) PCT Filed: Mar. 30, 2022
(86) PCT No.: PCT/CN2022/084061

§ 371 Date: Sep. 26, 2023

(30) Foreign Application Priority Data
May 28, 2021 (CN) 202110597135.0

(51) Int. Cl. H04W 52/02; H04W 4/029; H04W 4/80

(52) U.S. Cl. CPC H04W 52/028; H04W 4/029; H04W 4/80

(57) ABSTRACT

A low-power automatic network control method, apparatus, and device for a tracker, and a storage medium are disclosed. The method may include: performing, by the tracker, short-range communication with another device to determine whether the another device can provide a remote communication function for the tracker; disabling, by the tracker, a remote communication function of the tracker in response to determining that the another device can provide the remote communication function for the tracker; and performing, by the tracker after disabling the remote communication function, data exchange with a data center through the another device which can provide the remote communication function for the tracker.

### CROSS-REFERENCE TO RELATED APPLICATION

This application is a national stage filing under 35 U.S.C. § 371 of international application number PCT/CN2022/084061, filed Mar. 30, 2022, which claims priority to Chinese patent application No. 202110597135.0, filed May 28, 2021. The contents of these applications are incorporated herein by reference in their entirety.

### TECHNICAL FIELD

The present disclosure relates to the field of Internet of Things, and more particularly, to a low-power automatic network control method, apparatus, and device for a tracker, and a storage medium.

### BACKGROUND

In Internet of Things (IoT) systems, there are long-range communication modes such as 2nd-Generation Wireless Telephone Technology (2G), Long Term Evolution (LTE), and Narrow Band IoT (NB-IoT), as well as short-range communication modes such as Wireless Fidelity (WIFI), Bluetooth (BT), Near Field Communication (NFC), Zigbee, Ultra Wide Band (UWB), and Radio Frequency Identification (RFID). The co-existence of various long-range communication modes and short-range communication modes not only increases the difficulty of Printed Circuit Board (PCB) layout in products, but also increases the overall power consumption and overall heat generation.

As an important component in the layout of IoT systems, a tracker has limited space for PCBs, but has high requirements on power consumption and heat generation. Therefore, it is necessary to improve user experience of the tracker and reduce the overall heat generation and overall power consumption of the tracker.

### SUMMARY

The present disclosure provides an automatic network control method, apparatus, and device for a tracker, and a storage medium, to reduce the overall heat generation and overall power consumption of the tracker, so as to improve user experience of the tracker.

The present disclosure provides an automatic network control method for a tracker. The method includes: performing, by the tracker, short-range communication with another device to determine whether the another device can provide a remote communication function for the tracker; disabling, by the tracker, a remote communication function of the tracker in response to determining that the another device can provide the remote communication function for the tracker; and performing, by the tracker after disabling the remote communication function, data exchange with a data center through the another device which can provide the remote communication function for the tracker.

The present disclosure further provides an automatic network control device for a tracker. The device includes a memory, a processor, and a program stored in the memory and executable by the processor, where the program, when executed by the processor, causes the processor to implement the above automatic network control method for a tracker.

The present disclosure further provides a storage medium for computer-readable storage, where the storage medium storing a program which, when executed by a processor, causes the processor to implement the above automatic network control method for a tracker.

### BRIEF DESCRIPTION OF DRAWINGS

FIG. 1 is a flowchart of an automatic network control method for a tracker according to the present disclosure.

FIG. 2a is a schematic diagram of a first connection mode in which a plurality of trackers are close to each other and can be connected to each other according to the present disclosure.

FIG. 2b is a schematic diagram of a second connection mode in which a plurality of trackers are linearly arranged, for example, A is connected to B, B is connected to C, . . . , and N is connected to N+1, according to the present disclosure.

FIG. 2c is a schematic diagram of a third connection mode where a plurality of trackers are connected in both the first connection mode and the second connection mode according to the present disclosure.

FIG. 3 is a schematic diagram of network control for a tracker according to the present disclosure.

FIG. 4 is a flowchart of switching between a short-range communication network and a long-range communication network according to the present disclosure.

FIG. 5 is a structural block diagram of an automatic network control apparatus for a tracker according to the present disclosure.

### DETAILED DESCRIPTION

It should be understood that the embodiments described herein are merely used for illustrating the present disclosure, and are not intended to limit the present disclosure.

In the following description, suffixes such as “module”, “component”, or “unit” used to represent elements are used for facilitate the description of the present disclosure only, and do not have special meanings. Therefore, “module,” “component,” and “unit” can be used interchangeably.

Currently, there are more and more short-range communication devices. For example, mobile phones, automobiles, IoT products and the like can all realize short-range communication. A tracker can be used in combination with other trackers, mobile phones, automobiles, IoT products, and the like to realize short-range wireless communication and form an IoT network, thereby expanding the communication range. To improve user experience of the tracker and reduce the overall heat generation and overall power consumption of the tracker, the present disclosure proposes low-power automatic network control for a tracker, to realize switching between different network standards according to different application scenarios. In this scheme, the short-range communication mode is used as a main basis for control, and an operational status of a long-range communication circuit is controlled based on a connection status of short-range communication, thereby shortening the duration of long-range communication of the tracker and reducing the overall heat generation and overall power consumption of the tracker.

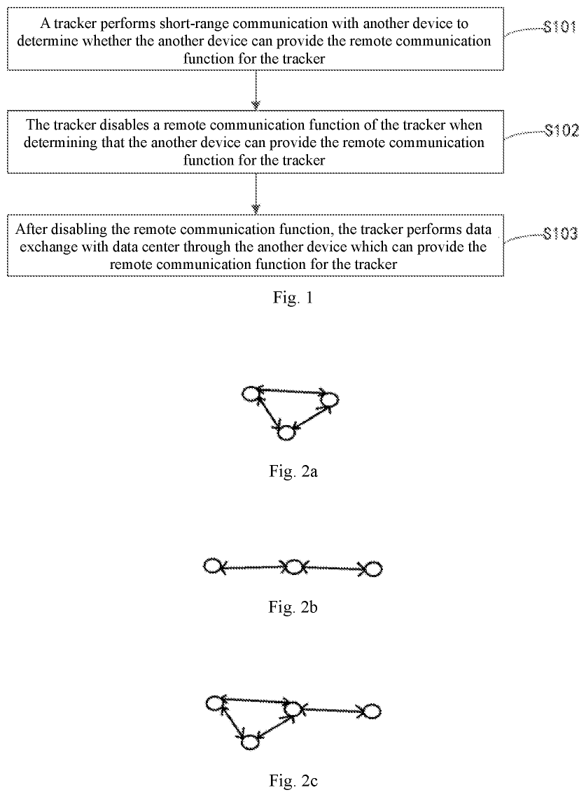

FIG. 1 is a flowchart of an automatic network control method for a tracker according to the present disclosure. As shown in FIG. 1, the method may include operations S101 to S103.

At S101, the tracker performs short-range communication with another device to determine whether the another device can provide the remote communication function for the tracker. At S102, the tracker disables a remote communication function of the tracker when determining that the another device can provide the remote communication function for the tracker. At S103, after disabling the remote communication function, the tracker performs data exchange with a data center through the another device which can provide the remote communication function for the tracker.

In the present disclosure, the tracker may be bound to a to-be-tracked object or perform short-range communication with the to-be-tracked object, to enable the to-be-tracked object such as an IoT device to join a network. In addition, through the another device which can provide the remote communication function for the tracker, the duration of operation of a remote communication function circuit in the tracker is minimized, thereby reducing the overall heat generation and overall power consumption of the tracker and improving user experience of the tracker. Especially when a plurality of trackers operate together, the trackers form a huge IoT network through a short-range communication network. Only a remote communication function of one tracker may need to be enabled in the entire network, thereby minimizing the power consumption of the plurality of trackers operating together.

Further, prior to S101, the method further includes: searching, by the tracker, for another device capable of short-range communication nearby; and connecting, by the tracker when finding another device capable of short-range communication nearby, to the another device capable of short-range communication through a short-range communication mode.

In an implementation, the another device includes another tracker and a non-tracker device, and S101 includes: determining, by the tracker, whether a non-tracker device exists in the another device performing short-range communication with the tracker; performing, by the tracker when determining that a non-tracker device exists in the another device performing short-range communication with the tracker, short-range communication with the non-tracker device to determine whether the non-tracker device can provide the remote communication function for the tracker; and in this way, when determining that there is a non-tracker device which can provide the remote communication function for the tracker, the tracker may select the non-tracker device as the remote communication device, to perform data exchange with the data center through the remote communication device. When there are a plurality of non-tracker devices which can provide the remote communication function for the tracker, the tracker may randomly select a non-tracker device as the remote communication device, or may select a non-tracker device with optimal remote communication signal quality as the remote communication device, etc.; Performing, by the tracker when determining that a non-tracker device exists in the another device performing short-range communication with the tracker and the non-tracker device cannot provide the remote communication function for the tracker or when determining that no non-tracker device exists in the another device performing short-range communication with the tracker, short-range communication with the another tracker to determine whether the another tracker can provide the remote communication function for the tracker, in this way, when determining that there is another tracker which can provide the remote communication function for the tracker, the tracker may select the another tracker as the remote communication device, to perform data exchange with the data center through the remote communication device. When there are a plurality of other trackers which can provide the remote communication function for the tracker, the tracker may randomly select one other tracker as the remote communication device, or may select one other tracker as the remote communication device according to a current network selection mode. For example, the tracker selects one other tracker with optimal remote communication signal quality as the remote communication device from the other trackers which can provide the remote communication function for the tracker when the current network selection mode is an optimal network mode; or the tracker selects one other tracker with the lowest power consumption as the remote communication device from the other trackers which can provide the remote communication function for the tracker when the current network selection mode is an optimal power consumption mode.

In another implementation, S101 includes: sending, by the tracker to the another device through short-range communication, a request message for communicating with the data center through the remote communication function provided by the another device; and determining, by the tracker, that the another device can provide the remote communication function for the tracker when receiving from the another device a response message indicating that the tracker is allowed to communicate with the data center through the remote communication function provided by the another device; or determining, by the tracker, that the another device cannot provide the remote communication function for the tracker when receiving from the another device a response message indicating that the another device does not have a remote communication capability or a response message indicating that the tracker is not allowed to communicate with the data center through the remote communication function provided by the another device. In this way, in case of presence of a plurality of other devices which can provide the remote communication function for the tracker, the tracker selects one other device as a remote communication device from the plurality of other devices which can provide the remote communication function for the tracker, to perform data exchange with the data center through the remote communication device. Upon making a decision, the following two cases are included. In a first case, in case of presence of a plurality of other devices which can provide the remote communication function for the tracker and the plurality of other devices which can provide the remote communication function for the tracker including at least one non-tracker device, the tracker selects a non-tracker device as the remote communication device from the at least one non-tracker device. In a second case, in case of presence of a plurality of other devices which can provide the remote communication function for the tracker and the plurality of other devices which can provide the remote communication function for the tracker being other trackers, the tracker selects, according to a current network selection mode, one other tracker as the remote communication device from the other trackers which can provide the remote communication function for the tracker. In an embodiment, the tracker selects one other tracker with optimal remote communication signal quality as the remote communication device from the other trackers which can provide the remote communication function for the tracker when the current network selection mode is an optimal network mode; or the tracker selects one other tracker with the lowest power consumption as the remote communication device from the other trackers which can provide the remote communication function for the tracker when the current network selection mode is an optimal power consumption mode.

In short, in the present disclosure, when the another device includes both a non-tracker device and another tracker, a remote communication function of the non-tracker device is preferentially used, thereby reducing the power consumption of the tracker and the power consumption of the plurality of trackers operating together.

Further, the method may further include: enabling, by the tracker, the remote communication function of the tracker when determining that the another device cannot provide the remote communication function for the tracker; and performing, by the tracker, data exchange with the data center through the remote communication function of the tracker, and providing the remote communication function for another tracker performing short-range communication with the tracker.

In an implementation, S103 further includes: maintaining, by the tracker after disabling the remote communication function, short-range communication with the selected other device (e.g., device X) which can provide the remote communication function. When the short-range communication between the tracker and the device X is interrupted, a remote communication network such as LTE of the tracker is enabled immediately, a warning indicating that the short-range communication with the device X is interrupted is sent to the data center, and a short-range communication network circuit of the tracker is kept in normal operation.

The present disclosure enables a to-be-tracked object such as an IoT device to join a network, and minimizes the duration of operation of the remote communication network circuit in the tracker. Especially when a plurality of trackers operate together, the trackers form a huge IoT network through a short-range communication network. Only a remote communication function of one device may need to be enabled in the entire network, thereby minimizing the power consumption of the plurality of trackers operating together.

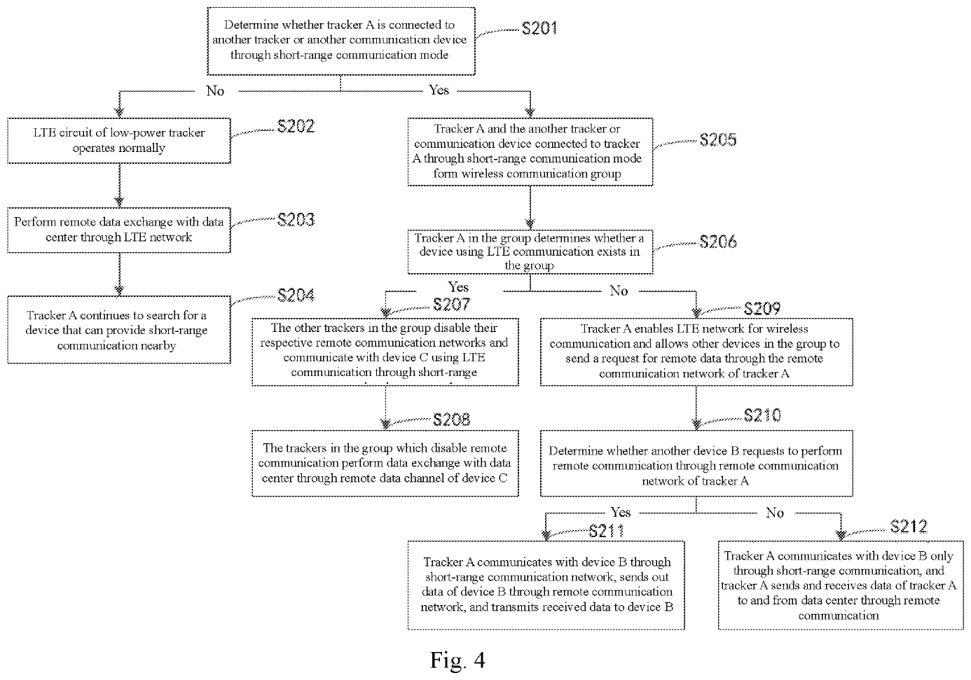

The present disclosure is described in detail with reference to FIG. 2a and FIG. 4.

As a complete product scheme, a tracker device usually may need to achieve a long standby time, low heat generation, and a small structure, and also to use short-range wireless communication and long-range wireless communication for device positioning and power consumption control.

A tracker may operate in the following scenarios.

(1) The tracker operates together with another device such as a mobile phone or a smart wearable device. The tracker sends a request for short-range communication with the another device such as the mobile phone or the smart wearable device, through WiFi, Bluetooth, NFC, or other short-range communication networks. After the another device such as the mobile phone or the smart wearable device accepts the request, the tracker successfully establishes a short-range communication connection with the another device such as the mobile phone or the smart wearable device for short-range communication. After the short-range communication connection is established, the tracker sends a request for “communicating with a data center through a remote communication network of the another device such as the mobile phone or the smart wearable device” to the another device such as the mobile phone or the smart wearable device. If the another device such as the mobile phone or the smart wearable device accepts the request, the tracker disables its long-range wireless communication network such as LTE to stop the operation of long-range wireless communication circuits such as an LTE circuit. In short, the tracker sends location information of the to-be-tracked object to the data center through a communication loop of “tracker—short-range communication network—another device such as mobile phone or smart wearable device—long-range communication network—data center”.

(2) A tracker A operates together with a plurality of trackers including a tracker B, a tracker C, a tracker D, . . . , and a tracker N. The plurality of trackers are close to each other. As shown in FIG. 2a, every two trackers in close proximity are connected to each other. Alternatively, as shown in FIG. 2b, trackers in close proximity are linearly arranged. For example, A is connected to B, B is connected to C, . . . , and N is connected to N+1. Alternatively, as shown in FIG. 2c, both the connection mode of FIG. 2a and the connection mode of FIG. 2b are included.

Each of the plurality of trackers sends a short-range communication request through WiFi, Bluetooth, NFC, or other short-range communication networks. After the trackers pass verification and establishes connections, a tracker Y connected to a largest number of trackers is preferably used as a remote communication device. The tracker Y enables its remote communication network to communicate with the data center. The other trackers disable their respective remote communication network circuits and transmit information to the tracker Y through short-range communication, and the information is then transmitted to the data center through the remote communication network of the tracker Y In short, the tracker sends location information of the to-be-tracked object to the data center through a communication loop of “tracker—short-range communication network—tracker Y—long-range communication network—data center”.

It should be noted that when there are two or more trackers connected to a same largest number of trackers, for example, as shown in FIG. 2a where three trackers are connected to each other and each tracker is connected to two trackers, the three trackers may exchange information through short-range communication. The information may be at least one of power consumption information, battery level information, or factory setting information. In an example where the information includes the power consumption information, the battery level information, and the factory setting information, the tracker with the lowest power consumption is used as the remote communication device. When the power consumption information cannot be obtained or there are trackers having the same power consumption, the tracker with a highest battery level is used as the remote communication device. When the battery level information cannot be obtained or there are trackers having the same battery level, the tracker with a latest ex-factory date is used as the remote communication device.

A network control process for a tracker is as follows.

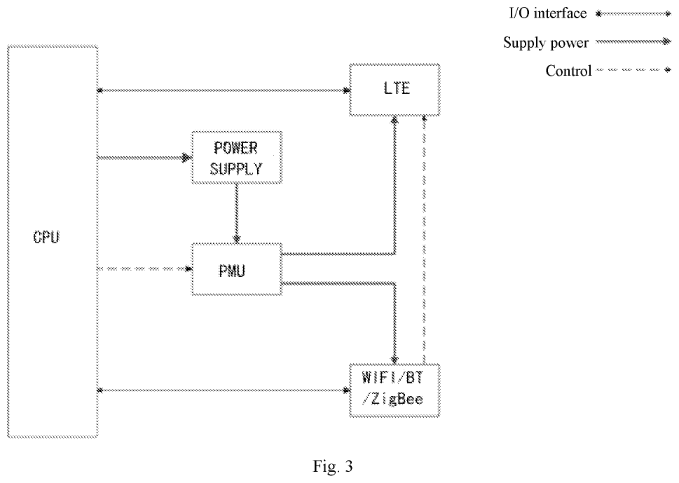

The tracker of the present disclosure can control short-range communication and long-range communication, and has a circuit structure as shown in FIG. 3. The tracker includes a Central Processing Unit (CPU), a Power Supply module, a Power Management Unit (PMU), a short-range communication circuit (e.g., WIFI circuit, Bluetooth circuit, NFC circuit, Zigbee circuit, UWB circuit, RFID circuit, etc.), and a long-range communication circuit (e.g., LTE circuit). The tracker uses the short-range communication circuit therein to communicate with a to-be-tracked object to determine that the tracker is in vicinity of the to-be-tracked object. The tracker uses the long-range communication circuit therein to implement remote communication between the tracker and a data center, and regularly sends a location status of the to-be-tracked object to the data center. In addition, when the distance between the tracker and the to-be-tracked object exceeds a monitoring distance, i.e., when the tracker is far away from the to-be-tracked object, the tracker also may need to send a warning to the data center through long-range communication.

The tracker of the present disclosure can realize low-power automatic network control. First, the tracker may connect to a network remotely, or may connect to another device through a short-range wireless network. For example, the tracker connects to a to-be-tracked object through WIFI, Bluetooth, NFC, Zigbee, UWB, RFID, or other networks; connects to a non-tracker device which can provide the remote communication function, such as a mobile phone, a smart wearable device, or a tablet computer, through WIFI, Bluetooth, NFC, Zigbee, UWB, RFID, or other networks; connects to another tracker through a remote wireless networks (i.e., long-range wireless network or long-range wireless communication network) such as LTE; and so on. When the tracker is not connected to a mobile phone, a smart wearable device, a tablet computer, another tracker, or other devices through the short-range communication network, the tracker switches to its own remote communication network such as LTE, i.e., enables its long-range communication circuit such as an LTE circuit to maintain communication with the data center through the long-range communication network such as LTE, and also maintains normal operation of its short-range communication circuit.

When the tracker is connected to a mobile phone, a smart wearable device, a tablet computer, another tracker, or other devices through the short-range communication network, for example, when the tracker is connected to another device A, the tracker first determines whether the another device A already enables its remote communication network such as LTE, and whether the tracker may need to implement network access by itself. If it is determined that the another device A is connected to a remote communication network such as LTE and the tracker is allowed to communicate with the data center through the remote communication network of the another device A, the PMU stops supplying power to the long-range communication circuit such as the LTE circuit to immediately disable the remote communication network such as LTE of the tracker, and continuously supplies power to the short-range communication circuit such as the WIFI, Bluetooth, NFC, Zigbee, UWB, or RFID circuit to maintain short-distance network communication between the tracker and the another device A.

In addition, when the short-range network communication between the tracker and the another device A is interrupted, the long-range communication network such as LTE of the tracker is enabled immediately, and at the same time, normal operation of the short-range communication network circuit of the tracker is maintained, and an alarm indicating that the short-range communication with the another device A is interrupted is sent to the data center. If it is determined that the another device A does not have a network access function or the tracker is not allowed to communicate with the data center through the remote communication network of the another device A, normal operation of the long-range wireless network such as LTE of the tracker is maintained.

In present disclosure, the short-range communication mode is used as a main basis for control, and an operational status of the long-range communication circuit is controlled based on a remote communication network provisioning status received from another device through the short-range communication circuit. To be specific, when another device can provide the remote communication function for the tracker, the long-range communication network circuit such as the LTE circuit is controlled to be disabled; when no other device can provide the remote communication function for the tracker, the long-range communication network circuit such as the LTE circuit is controlled to be enabled. Whereby, the duration of long-range communication of the tracker is shortened, and the overall heat generation and overall power consumption of the tracker are reduced.

FIG. 4 shows a process of a tracker switching between a short-range communication network and a long-range communication network, including the following operations S201 to S212.

At S201, it is determined whether a tracker A is connected to another tracker or another communication device through a short-range communication mode. When it is determined that the tracker A is connected to another tracker or another communication device through the short-range communication mode, S205 to S206 are performed; otherwise, S202 to S204 are performed.

At S202 to S204, an LTE circuit of the tracker A operates normally to perform remote data exchange with a data center through an LTE network, and continues to search for a device which can provide short-range communication nearby.

At S205, the tracker A and the another tracker or communication device connected to the tracker A through the short-range communication mode form a wireless communication group, and it is determined whether a device using LTE communication exists in the wireless communication group. When it is determined that a device using LTE communication exists in the wireless communication group, S207 to S208 are performed; otherwise, S209 to S210 are performed.

At S207 to S208, when a device C in the wireless communication group uses LTE communication, other trackers including the tracker Ain the group disable their respective remote communication networks and communicate with the device C using LTE communication through a short-range communication network, and the trackers in the group which disable their remote communication networks perform data exchange with the data center through a remote data channel of the device C.

At S209 to S210, when no device using LTE communication exists in the wireless communication group, the tracker A enables its own LTE network for wireless communication and allows other devices in the group to perform remote communication through the remote communication network of the tracker A, and then determines whether another device B in the group requests to perform remote communication through the remote communication network of the tracker A. If it is determined that the another device B in the group requests to perform remote communication through the remote communication network of the tracker A, S211 is performed; otherwise, S212 is performed.

At S211, the tracker A communicates with the device B through the short-range communication network, sends out data of the device B through the remote communication network, and transmits received data to the device B.

At S212, the tracker A communicates with the device B only through short-range communication, and the tracker A sends and receives data of the tracker A to and from the data center through remote communication.

In the present disclosure, through the another device which can provide the remote communication function for the tracker, the duration of operation of a remote communication function circuit in the tracker is minimized, thereby reducing the overall heat generation and overall power consumption of the tracker and improving user experience of the tracker. Especially when a plurality of trackers operate together, the trackers form a huge IoT network through a short-range communication network. The present disclosure enables a to-be-tracked object such as an IoT device to join a network. In addition, through the another device which can provide the remote communication function for the tracker, the duration of operation of a remote communication function circuit in the tracker is minimized, thereby reducing the overall heat generation and overall power consumption of the tracker and improving user experience of the tracker. Especially when a plurality of trackers operate together, the trackers form a huge IoT network through a short-range communication network. Only a remote communication function of one tracker may need to be enabled in the entire network, thereby minimizing the power consumption of the plurality of trackers operating together.

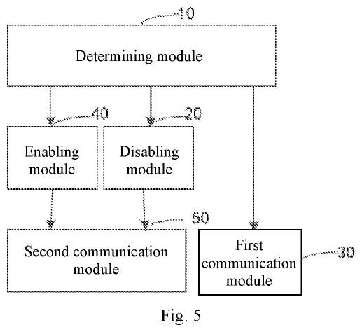

FIG. 5 is a structural block diagram of an automatic network control apparatus for a tracker according to the present disclosure. As shown in FIG. 5, the apparatus may include a determining module 10, a disabling module 20, and a first communication module 30.

The determining module 10 is configured for enabling the tracker to perform short-range communication with another device to determine whether the another device can provide the remote communication function for the tracker. The disabling module 20 is configured for disabling a remote communication function of the tracker when determining that the another device can provide the remote communication function for the tracker. The first communication module 30 is configured for performing data exchange with a data center through the another device which can provide the remote communication function for the tracker.

The determining module 10 is further configured for searching for another device capable of short-range communication in vicinity of the tracker; and when finding another device capable of short-range communication in vicinity of the tracker, connecting the tracker to the another device capable of short-range communication through a short-range communication mode.

In an implementation, the another device includes a non-tracker device and another tracker. The determining module 10 is configured for determining whether a non-tracker device exists in the another device performing short-range communication with the tracker; when determining that a non-tracker device exists in the another device performing short-range communication with the tracker, enabling the tracker to perform short-range communication with the non-tracker device to determine whether the non-tracker device can provide the remote communication function for the tracker; and in this way, when determining that there is a non-tracker device which can provide the remote communication function for the tracker, selecting the non-tracker device as the remote communication device to perform data exchange with the data center through the remote communication device. When there are a plurality of non-tracker devices which can provide the remote communication function for the tracker, randomly selecting a non-tracker device as the remote communication device, or selecting a non-tracker device with optimal remote communication signal quality as the remote communication device, etc.; when determining that a non-tracker device exists in the another device performing short-range communication with the tracker and the non-tracker device cannot provide the remote communication function for the tracker or when determining that no non-tracker device exists in the another device performing short-range communication with the tracker, enabling the tracker to perform short-range communication with the another tracker to determine whether the another tracker can provide the remote communication function for the tracker, in this way, when determining that there is another tracker which can provide the remote communication function for the tracker, selecting the another tracker as the remote communication device to perform data exchange with the data center through the remote communication device. When there are a plurality of other trackers which can provide the remote communication function for the tracker, randomly selecting one other tracker as the remote communication device, or may select one other tracker as the remote communication device according to a current network selection mode. For example, selecting one other tracker with optimal remote communication signal quality as the remote communication device from the other trackers which can provide the remote communication function for the tracker when the current network selection mode is an optimal network mode; or selecting one other tracker with lowest power consumption as the remote communication device from the other trackers which can provide the remote communication function for the tracker when the current network selection mode is an optimal power consumption mode.

In another implementation, the determining module 10 is configured for sending, to the another device through short-range communication, a request message for communicating with the data center through the remote communication function provided by the another device; and determining that the another device can provide the remote communication function for the tracker when receiving from the another device a response message indicating that the tracker is allowed to communicate with the data center through the remote communication function provided by the another device; or determining that the another device cannot provide the remote communication function for the tracker when receiving from the another device a response message indicating that the another device does not have a remote communication capability or a response message indicating that the tracker is not allowed to communicate with the data center through the remote communication function provided by the another device. In this way, in case of presence of a plurality of other devices which can provide the remote communication function for the tracker, the determining module 10 selects one other device as a remote communication device from the plurality of other devices which can provide the remote communication function for the tracker to perform data exchange with the data center through the remote communication device. Upon making a decision, the following two cases are included. In a first case, in case of presence of a plurality of other devices which can provide the remote communication function for the tracker and the plurality of other devices which can provide the remote communication function for the tracker including at least one non-tracker device, the determining module 10 selects one non-tracker device as the remote communication device from the at least one non-tracker device. In a second case, in case of presence of a plurality of other devices which can provide the remote communication function for the tracker and the plurality of other devices which can provide the remote communication function for the tracker being other trackers, the determining module 10 selects, according to a current network selection mode, one other tracker as the remote communication device from the other trackers which can provide the remote communication function for the tracker. In an example embodiment, the determining module 10 selects one other tracker with optimal remote communication signal quality as the remote communication device from the other trackers which can provide the remote communication function for the tracker when the current network selection mode is an optimal network mode; or the determining module 10 selects one other tracker with the lowest power consumption as the remote communication device from the other trackers which can provide the remote communication function for the tracker when the current network selection mode is an optimal power consumption mode.

That is to say, in the present disclosure, when the another device includes both a non-tracker device and another tracker, a remote communication function of the non-tracker device is preferentially used, thereby reducing the power consumption of the tracker and the power consumption of the plurality of trackers operating together.

The apparatus further includes an enabling module 40 and a second communication module 50.

The enabling module 40 is configured for enabling the remote communication function of the tracker when determining that the another device cannot provide the remote communication function for the tracker. The second communication module 50 is configured for performing data exchange with the data center through the remote communication function of the tracker.

The apparatus of the present disclosure is applied to a tracker, and enables a to-be-tracked object such as an IoT device to join a network. In addition, through the another device which can provide the remote communication function for the tracker, the duration of operation of a remote communication function circuit in the tracker is minimized, thereby reducing the overall heat generation and overall power consumption of the tracker and improving user experience of the tracker.

The present disclosure further provides an automatic network control device for a tracker. The device includes a memory, a processor, and a program stored in the memory and executable by the processor, where the program, when executed by the processor, causes the processor to implement the automatic network control method for a tracker. The memory includes, but not limited to, a Random Access Memory (RAM), a Read-Only Memory (ROM), an Electrically Erasable Programmable Read-Only Memory (EEPROM), etc. The processor includes, but not limited to, a central processing unit, a digital signal processor, a microprocessor, etc.

The present disclosure further provides a storage medium for computer-readable storage, where the storage medium storing a program which, when executed by a processor, causes the processor to implement the automatic network control method for a tracker. The storage medium includes, but not limited to, a RAM, a ROM, an EEPROM, a flash memory or other memory technology, a Compact Disc Read-Only Memory (CD-ROM), a Digital Versatile Disc (DVD) or other optical storage, a cassette, a magnetic tape, a magnetic disk storage or other magnetic storage device, or any other medium which can be used to store the desired information and which can be accessed by a computer.

According to the automatic network control method, apparatus, and device for a tracker, and the storage medium provided in the present disclosure, the tracker performs short-range communication with another device to determine whether the another device can provide the remote communication function for the tracker. The tracker disables a remote communication function of the tracker when determining that the another device can provide the remote communication function for the tracker. After disabling the remote communication function, the tracker performs data exchange with a data center through the another device which can provide the remote communication function for the tracker. The present disclosure enables a to-be-tracked object such as an IoT device to join a network, and minimizes the duration of operation of a remote communication function circuit in the tracker, thereby reducing the overall heat generation and overall power consumption of the tracker and improving user experience of the tracker. Especially when a plurality of trackers operate together, the trackers form a huge IoT network through a short-range communication network. Only a remote communication function of one tracker may need to be enabled in the entire network, thereby minimizing the power consumption of the plurality of trackers operating together.

Although embodiments of the present disclosure are described above with reference to the accompanying drawings, these embodiments are not intended to limit the protection scope of the present disclosure. Any modifications, equivalent replacements and improvements made by those having ordinary skills in the art without departing from the scope and essence of the present disclosure shall fall within the protection scope of the present disclosure.

1. An automatic network control method for a tracker, the method comprising:
performing, by the tracker, short-range communication with another device to determine whether the another device can provide a remote communication function for the tracker;
disabling, by the tracker, a remote communication function of the tracker in response to determining that the another device can provide the remote communication function for the tracker; and
performing, by the tracker after disabling the remote communication function, data exchange with a data center through the another device which can provide the remote communication function for the tracker.

2. The method of claim 1, wherein prior to performing, by the tracker, short-range communication with another device to determine whether the another device can provide a remote communication function for the tracker, the method further comprises:
searching, by the tracker, for another device capable of short-range communication nearby; and
connecting, by the tracker in response to finding another device capable of short-range communication nearby, to the another device capable of short-range communication through a short-range communication mode.

3. The method of claim 1, wherein the another device comprises another tracker and a non-tracker device, and performing, by the tracker, short-range communication with another device to determine whether the another device can provide a remote communication function for the tracker comprises:
determining, by the tracker, whether a non-tracker device exists in the another device performing short-range communication with the tracker;
performing, by the tracker in response to determining that a non-tracker device exists in the another device performing short-range communication with the tracker, short-range communication with the non-tracker device to determine whether the non-tracker device can provide the remote communication function for the tracker; and
performing, by the tracker in response to determining that a non-tracker device exists in the another device performing short-range communication with the tracker and the non-tracker device cannot provide the remote communication function for the tracker or in response to determining that no non-tracker device exists in the another device performing short-range communication with the tracker, short-range communication with the another tracker to determine whether the another tracker can provide the remote communication function for the tracker.

4. The method of claim 1, wherein performing, by the tracker, short-range communication with another device to determine whether the another device can provide a remote communication function for the tracker comprises:
sending, by the tracker to the another device through short-range communication, a request message for communicating with the data center through the remote communication function provided by the another device; and
determining, by the tracker, that the another device can provide the remote communication function for the tracker, in response to receiving from the another device a response message indicating that the tracker is allowed to communicate with the data center through the remote communication function provided by the another device; or determining, by the tracker, that the another device cannot provide the remote communication function for the tracker, in response to receiving from the another device a response message indicating that the another device does not have a remote communication capability or a response message indicating that the tracker is not allowed to communicate with the data center through the remote communication function provided by the another device.

5. The method of claim 1, wherein after performing, by the tracker, short-range communication with another device to determine whether the another device can provide a remote communication function for the tracker, the method further comprises:
selecting, by the tracker in response to presence of a plurality of other devices which can provide the remote communication function for the tracker, one other device as a remote communication device from the plurality of other devices which can provide the remote communication function for the tracker, to perform data exchange with the data center through the remote communication device.

6. The method of claim 5, wherein selecting, by the tracker, one other device as a remote communication device from the plurality of other devices which can provide a remote communication function for the tracker comprises:
selecting, by the tracker in response to presence of a plurality of other devices which can provide the remote communication function for the tracker and the plurality of other devices which can provide the remote communication function for the tracker comprising at least one non-tracker device, one non-tracker device as the remote communication device from the at least one non-tracker device; and
selecting, by the tracker according to a current network selection mode in response to presence of a plurality of other devices which can provide the remote communication function for the tracker and the plurality of other devices which can provide the remote communication function for the tracker being other trackers, one other tracker as the remote communication device from the other trackers which can provide the remote communication function for the tracker.

7. The method of claim 6, wherein selecting, by the tracker according to a current network selection mode, one other tracker as the remote communication device from the other trackers which can provide a remote communication function for the tracker comprises:
selecting, by the tracker, one other tracker with optimal remote communication signal quality as the remote communication device from the other trackers which can provide the remote communication function for the tracker, in response to the current network selection mode being an optimal network mode; or
selecting, by the tracker, one other tracker with the lowest power consumption as the remote communication device from the other trackers which can provide the remote communication function for the tracker, in response to the current network selection mode being an optimal power consumption mode.

8. The method of claim 1, wherein the method further comprises:
enabling, by the tracker, the remote communication function of the tracker in response to determining that the another device cannot provide the remote communication function for the tracker; and
performing, by the tracker, data exchange with the data center through the remote communication function of the tracker, and providing the remote communication function for another tracker performing short-range communication with the tracker.

9. An automatic network control device for a tracker, the device comprising a memory, a processor, and a program stored in the memory and executable by the processor, wherein the program, when executed by the processor, causes the processor to perform an automatic network control method, the method comprising:
performing, by the tracker, short-range communication with another device to determine whether the another device can provide a remote communication function for the tracker;
disabling, by the tracker, a remote communication function of the tracker in response to determining that the another device can provide the remote communication function for the tracker; and
performing, by the tracker after disabling the remote communication function, data exchange with a data center through the another device which can provide the remote communication function for the tracker.

10. A non-transitory computer-readable storage medium, wherein the storage medium storing a program which, when executed by a processor, causes the processor to perform an automatic network control method, the method comprising:
performing, by the tracker, short-range communication with another device to determine whether the another device can provide a remote communication function for the tracker;
disabling, by the tracker, a remote communication function of the tracker in response to determining that the another device can provide the remote communication function for the tracker; and
performing, by the tracker after disabling the remote communication function, data exchange with a data center through the another device which can provide the remote communication function for the tracker.

11. The method of claim 2, wherein the method further comprises:
enabling, by the tracker, the remote communication function of the tracker in response to determining that the another device cannot provide the remote communication function for the tracker; and
performing, by the tracker, data exchange with the data center through the remote communication function of the tracker, and providing the remote communication function for another tracker performing short-range communication with the tracker.

12. The method of claim 3, wherein the method further comprises:
enabling, by the tracker, the remote communication function of the tracker in response to determining that the another device cannot provide the remote communication function for the tracker; and
performing, by the tracker, data exchange with the data center through the remote communication function of the tracker, and providing the remote communication function for another tracker performing short-range communication with the tracker.

13. The method of claim 4, wherein the method further comprises:
enabling, by the tracker, the remote communication function of the tracker in response to determining that the another device cannot provide the remote communication function for the tracker; and
performing, by the tracker, data exchange with the data center through the remote communication function of the tracker, and providing the remote communication function for another tracker performing short-range communication with the tracker.

14. The method of claim 5, wherein the method further comprises:
enabling, by the tracker, the remote communication function of the tracker in response to determining that the another device cannot provide the remote communication function for the tracker; and
performing, by the tracker, data exchange with the data center through the remote communication function of the tracker, and providing the remote communication function for another tracker performing short-range communication with the tracker.

15. The method of claim 6, wherein the method further comprises:
enabling, by the tracker, the remote communication function of the tracker in response to determining that the another device cannot provide the remote communication function for the tracker; and
performing, by the tracker, data exchange with the data center through the remote communication function of the tracker, and providing the remote communication function for another tracker performing short-range communication with the tracker.

16. The method of claim 7, wherein the method further comprises:
enabling, by the tracker, the remote communication function of the tracker in response to determining that the another device cannot provide the remote communication function for the tracker; and
performing, by the tracker, data exchange with the data center through the remote communication function of the tracker, and providing the remote communication function for another tracker performing short-range communication with the tracker.
